(19) United States
(12) Patent Application Publication
(10) Pub. No.: US 2007/0120777 A1
(43) Pub. Date: May 31, 2007

(54) Light emitting device and method of driving the same

(75) Inventor: Ji Hun Kim, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/377,274

(22) Filed: Mar. 17, 2006

(30) Foreign Application Priority Data
Nov. 30, 2005 (KR) 10-2005-0115630

(51) Int. Cl. G09G 3/30

(52) U.S. Cl. 345/76

(57) ABSTRACT

The present invention relates to a light emitting device to which cross-talk phenomenon is not occurred. The light emitting device includes data lines, scan lines, a plurality of pixels, and a discharging circuit. The data lines are disposed in a first direction. The scan lines are disposed in a second direction different from the first direction. The pixels are formed in cross areas of the data lines and the scan lines. The discharging circuit discharges at least one data line to a discharge voltage corresponding to a cathode voltage of a pixel corresponding to the data line. In the light emitting device, the discharge voltages are changed depending on the cathode voltages, and thus the cross-talk phenomenon is not occurred.

### BACKGROUND OF THE INVENTION

1. Field of the Invention

The present invention relates to a light emitting device, and a method of driving the same. Particularly, the present invention relates to a light emitting device in which cross-talk phenomenon is not occurred, and a method of driving the same.

2. Description of the Related Art

A light emitting device emits a light having a certain wavelength when a predetermined voltage is provided thereto.

FIG. 1 is a block diagram illustrating a common light emitting device.

In FIG. 1, the light emitting device includes a panel 100, a controller 102, a first scan driving circuit 106, a discharging circuit 108, a precharging circuit 110, and a data driving circuit 112.

The panel 100 includes a plurality of pixels E11 to E44 formed in cross areas of data lines D1 to D4 and scan lines S1 to S4.

The controller 302 receives display data from an outside apparatus, and controls the scan driving circuits 104 and 106, the discharging circuit 108, the precharging circuit 110, and the data driving circuit 112, by using the received display data.

The first scan driving circuit 104 transmits first scan signals to a part of the scan lines S1 to S4, e.g. S1 and S3.

The second scan driving circuit 106 transmits second scan signals to the other scan lines S2 and S4. As a result, the scan lines S1 to S4 are connected in sequence to a ground.

The discharging circuit 108 is connected to the data lines D1 to D4, and discharges the data lines to a certain discharge voltage. For example, the discharging circuit 108 discharges the data lines D1 to D4 to a zener voltage of a zener diode ZD by using the zener diode included therein.

The precharging circuit 110 provides a precharge current corresponding to the display data to the discharged data lines D1 to D4 under control of the controller 102.

The data driving circuit 112 provides data signals, i.e. data current, corresponding to the display data to the precharged data lines D1 to D4 under control of the controller 102. As a result, pixels E11 to E44 emit a light.

FIG. 2A and FIG. 2B are views schematically illustrating circuitries of the light emitting device of FIG. 1. FIG. 2C and FIG. 2D are timing diagrams illustrating a process of driving the light emitting device.

Hereinafter, cathode voltages VC11 to VC44 will be explained, and then the process of driving the light emitting device will be described in detail. Here, cathode voltages VC11 to VC 41 of the pixels E11 to E41 corresponding to a first scan line S1 will be described as an example of the cathode voltages VC11 to VC44 for convenience of the description.

First, the cathode voltages VC11 to VC44 will be explained.

As shown in FIG. 2A, a resistor between a pixel E11 and the ground is scan resistor Rs, and a resistor between a pixel E21 and the ground is Rs+Rp. In addition, a resistor between a pixel E31 and the ground is Rs+2 Rp, and a resistor between a pixel E41 and the ground is Rs+3 Rp. Here, the cathode voltages VC11 to VC41 of the pixels E11 to E41 are proportioned to corresponding resistors, and thus the cathode voltages VC41, VC31, VC21 and VC11 have sequential magnitude.

In FIG. 2B, a resistor between a pixel E12 and the ground is Rs+3 Rp, and so a cathode voltage VC12 is higher than the cathode voltage VC11.

Second, the process of driving the light emitting device will be described in detail.

A switch SW is turned on, and so the data lines D1 to D4 are discharged to a certain discharge voltage during a first discharge period of time (dcha1). In this case, the scan lines S1 to S4 are coupled to a non-luminescent source having same magnitude as a driving voltage of the light emitting device.

Subsequently, a precharge current corresponding to first display data is provided to the data lines D1 to D4.

Then, the first scan line S1 is coupled to the ground as shown in FIG. 2A, and the other scan lines S2 to S4 are coupled to the non-luminescent source.

Subsequently, data currents 111, 121, 131 and 141 corresponding to the first display data are provided to the data lines D1 to D4. As a result, the pixels E11 to E41 emit a light during a first luminescent period of time.

Hereinafter, the pixel E41 is preset to have same brightness as the pixel E11.

At the time of discharge, the data lines D1 and D4 are discharged to the same discharge voltage, and so anode voltages VA11 and VA41 of pixels E11 and E41 have same magnitude according to the data currents I11 and I41, as shown in FIG. 2D. In this case, the pixel E11 emits a light having a brightness corresponding to the difference of the anode voltage VA11 and the cathode voltage VC11, and the pixel E41 emits a light having a brightness corresponding to the difference of the anode voltage VA41 and the cathode voltage VC41. Here, the anode voltages VA11 and VA41 have same magnitude, but the cathode voltage VC41 is higher than the cathode voltage VC11. Accordingly, though the pixels E11 and E41 are preset to emit a light having the same brightness, the pixel E41 has brightness smaller than the pixel E11. This is referred to as cross-talk phenomenon.

The process of driving the light emitting device will be described below.

The scan lines S1 to S4 are coupled to the non-luminescent source, and the switch SW is turned on. As a result, the data lines D1 to D4 are discharged up to a certain discharge voltage during a second discharge period of time (dcha2).

Subsequently, a precharge current corresponding to second display data is provided to the data lines D1 to D4, wherein the second display data are inputted to the controller 102 after the first display data are inputted to the controller 102.

Then, the second scan line S2 is coupled to the ground, and the other scan lines S1, S3 and S4 are coupled to the non-luminescent source.

Subsequently, data currents 112, 122, 132 and 142 corresponding to the second display data are provided to the data lines D1 to D4, and so the pixels E12 to E42 emit a light during a second luminescent period of time (t2).

Below, the pixel E12 is assumed to be designed to have the same brightness as the pixel E11. Here, a discharge voltage corresponding to the second discharge period of time (dcha2) is substantially identical to the discharge voltage corresponding to the first discharge period of time (dcha1), and thus an anode voltage VA12 has same magnitude as the anode voltage VA11. In this case, the pixel E11 emits a light having a brightness corresponding to the difference of the anode voltage VA11 and the cathode voltage VC11, and the other pixel E12 emits a light having a brightness corresponding to the difference of the anode voltage VA12 and the cathode voltage VC12. Here, the anode voltage VA11 and VA12 have same magnitude, but the cathode voltage VC12 is higher than the cathode voltage VC11. Accordingly, though the pixels E11 and E12 are preset to have the same brightness, the pixel E12 has brightness smaller than the other pixel E11.

### SUMMARY OF THE INVENTION

It is a feature of the present invention to provide a light emitting device in which cross-talk phenomenon is not occurred and a method of driving the same.

According to one embodiment of the present invention, a light emitting device includes data lines, scan lines, a plurality of pixels, and a discharging circuit. The data lines are disposed in a first direction. The scan lines are disposed in a second direction different from the first direction. The pixels are formed in cross areas of the data lines and the scan lines. The discharging circuit discharges at least two data lines. Here, the two data lines are discharged to different discharge voltages.

According to another embodiment of the present invention, a light emitting device includes data lines, scan lines, and a plurality of pixels. The data lines are disposed in a first direction. The scan lines are disposed in a second direction different from the first direction. The pixels are formed in cross areas of the data lines and the scan lines. Here, an anode voltage of at least one pixel has magnitude corresponding to its cathode voltage and display data.

According to another embodiment of the present invention, an electroluminescent device includes data lines, scan lines, a plurality of pixels, a first sub discharging circuit, and a second sub discharging circuit. The data lines are disposed in a first direction. The scan lines are disposed in a second direction different from the first direction. The pixels are formed in cross areas of the data lines and the scan lines. The first sub discharging circuit provides a first voltage to a first outmost data line of the data lines. The second sub discharging circuit provides a second voltage to a second outmost data line. Here, the second voltage has different magnitude from the first voltage. When a data current of same brightness is provided to the data lines, each anode voltages of pixels corresponding to the scan line has different magnitude depending on corresponding cathode voltage.

A method of driving a light emitting device having a plurality of pixels formed in cross areas of data lines and scan lines according to one embodiment of the present invention includes providing a first voltage to a first outmost data line of the data lines; and providing a second voltage to a second outmost data line. Here, each anode voltage of pixels corresponding to the scan line has different size depending on corresponding cathode voltage.

As described above, in the light emitting device and the method of driving the same according to one embodiment of the present invention, the discharge voltages are changed depending on the cathode voltages, and thus cross-talk phenomenon is not occurred.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a block diagram illustrating a common light emitting device;

FIG. 2A and FIG. 2B are views illustrating circuitries of the light emitting device of FIG. 1;

FIG. 2C and FIG. 2D are timing diagrams illustrating a process of driving the light emitting device;

FIG. 3 is a block diagram illustrating a light emitting device according to a first embodiment of the present invention;

FIG. 4A and FIG. 4B are views illustrating circuitries of the light emitting device of FIG. 3;

FIG. 4C and FIG. 4D are timing diagrams illustrating a process of driving the light emitting device;

FIG. 5 is a view illustrating a circuitry of a light emitting device according to a second embodiment of the present invention;

FIG. 6 is a block diagram illustrating a light emitting device according to a third embodiment of the present invention;

FIG. 7 is a view illustrating a circuitry of the light emitting device of FIG. 6; and

FIG. 8 is a block diagram illustrating a light emitting device according to a fourth embodiment of the present invention.

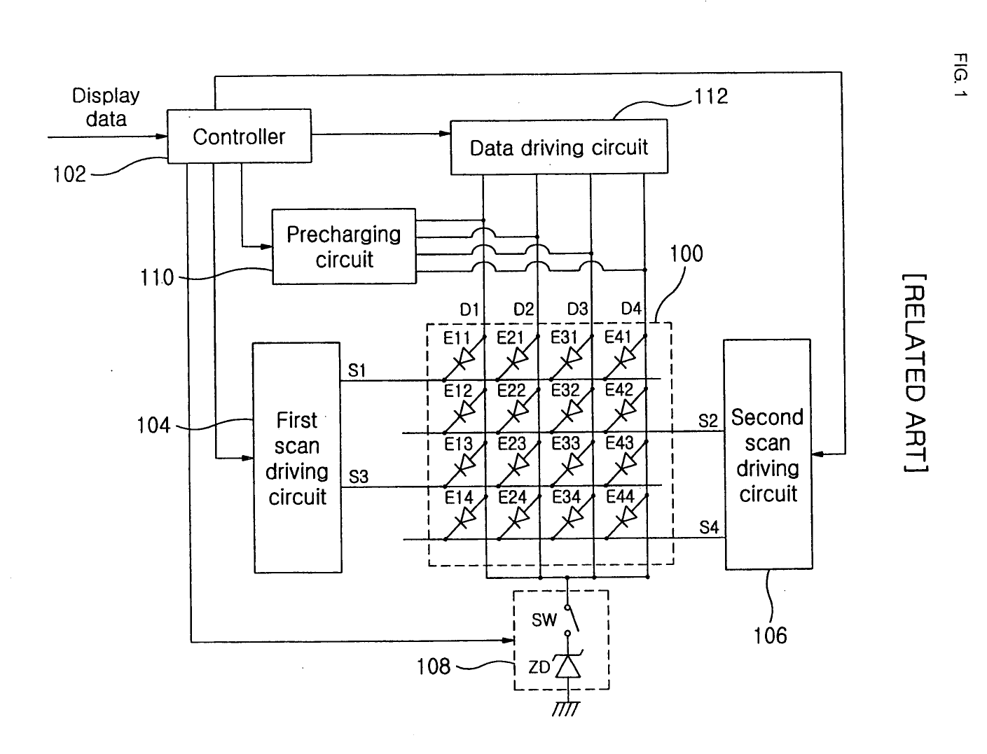

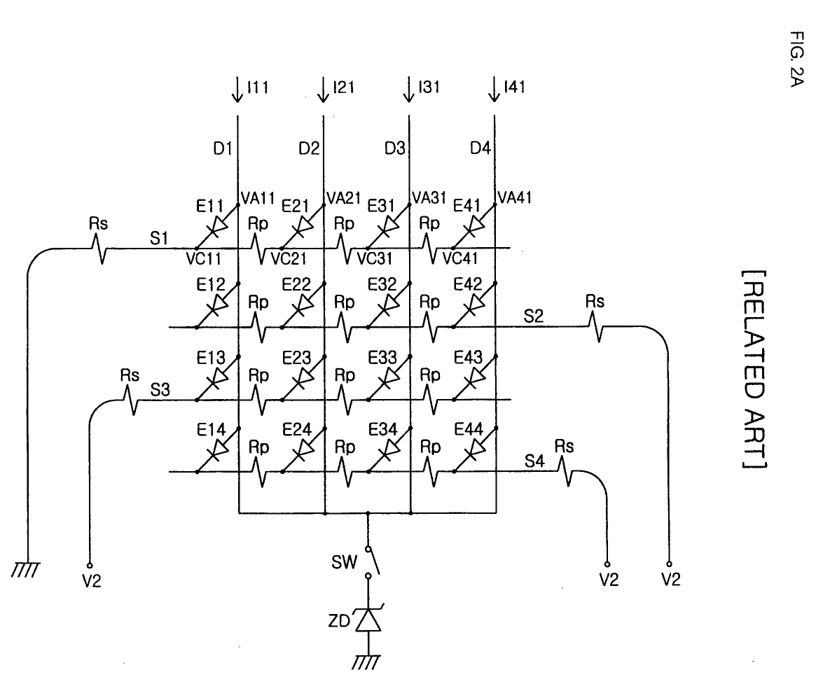

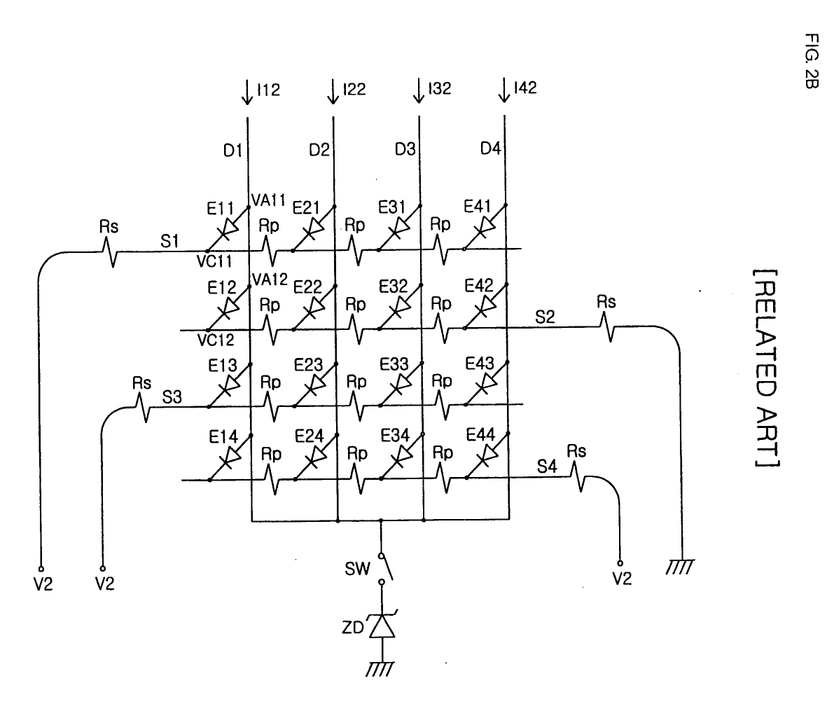

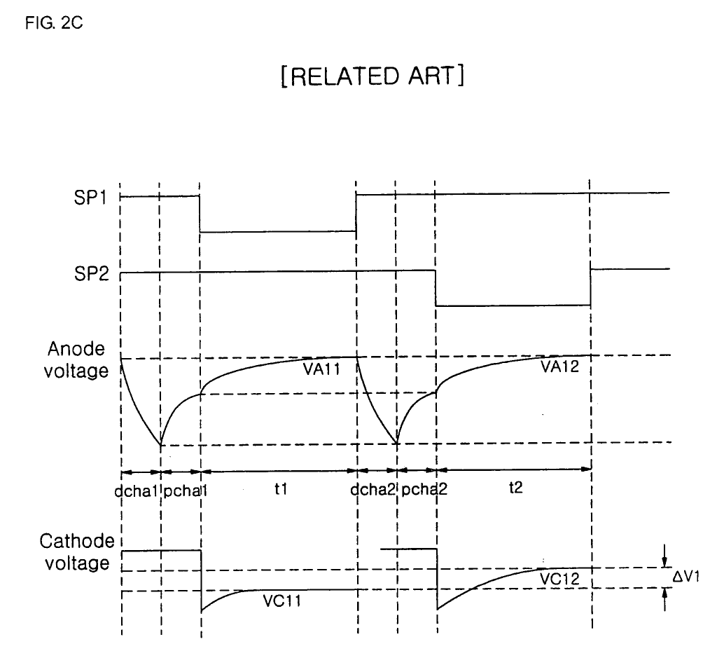

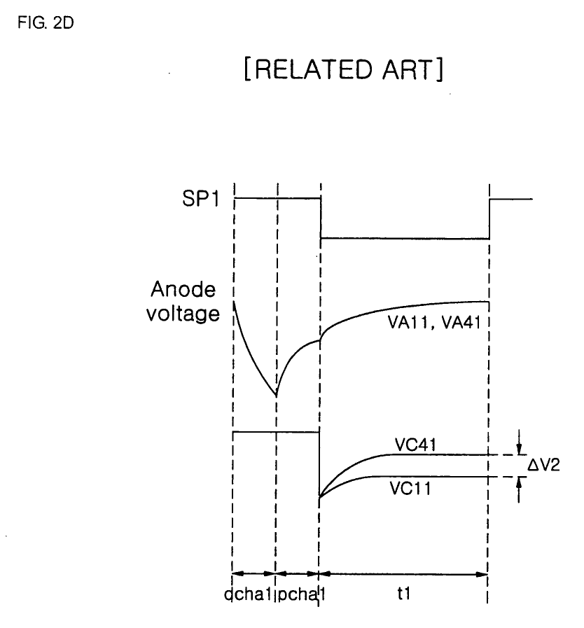

### DESCRIPTION OF EMBODIMENTS

Hereinafter, preferred embodiments of the present invention will be explained in more detail with reference to the accompanying drawings.

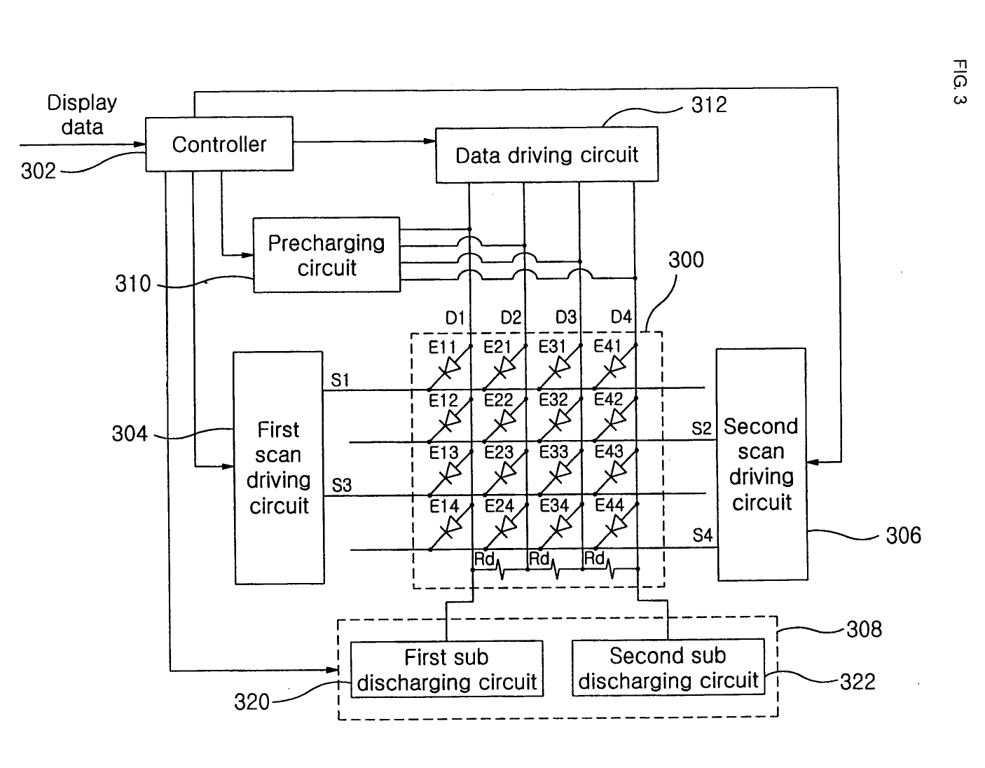

FIG. 3 is a block diagram illustrating a light emitting device according to a first embodiment of the present invention.

In FIG. 3, the light emitting device of the present invention includes a panel 300, a controller 302, a first scan driving circuit 304, a second scan driving circuit 306, a discharging circuit 308, a precharging circuit 310, and a data driving circuit 312.

The light emitting device according to one embodiment of the present invention includes an organic electroluminescent device, a plasma display panel, a liquid crystal display, and others. Hereinafter, the organic electroluminescent device will be described as an example of the light emitting device for convenience of the description.

The panel 300 includes a plurality of pixels E11 to E44 formed in cross areas of data lines D1 to D4 and scan lines S1 to S4.

Each of the pixels E11 to E44 includes an anode electrode layer, an organic layer, and a cathode electrode layer formed in sequence on a substrate.

The controller 302 receives display data, e.g. RGB data, inputted from an outside apparatus, and controls the scan driving circuits 304 and 306, the discharging circuit 308, the precharging circuit 310, and the data driving circuit 312, by using the received display data. In addition, the controller 302 may store the received display data in its memory.

The first scan driving circuit 304 transmits first scan signals to a part of the scan lines S1 to S4, e.g. S1 and S3.

The second scan driving circuit 306 transmits second scan signals to the other scan lines S2 and S4. As a result, the scan lines S1 to S4 are coupled to a luminescent source, e.g. ground.

The discharging circuit 308 makes the data lines D1 to D4 discharge voltages corresponding to cathode voltages of the pixels E11 to E44, and includes a first sub discharging circuit 320 and a second sub discharging circuit 322.

The first sub discharging circuit 320 is coupled to a first outmost data line D1 of outmost data lines D1 and D4 as shown in FIG. 3, and provides a first voltage to the first outmost data line D1.

The second sub discharging circuit 322 is coupled to a second outmost data line D4 as shown in FIG. 3, and provides a second voltage to the second outmost data line D4. Here, the second voltage has a different magnitude from the first voltage.

Hereinafter, the sub discharging circuits 320 and 322 will be explained in more detail with reference to the accompanying drawings.

The precharging circuit 310 provides a precharge current corresponding to the display data to the discharged data lines D1 to D4 under control of the controller 302.

The data driving circuit 312 provides data signals, i.e. data current, corresponding to the display data to the precharged data lines D1 to D4 under control of the controller 302. As a result, the pixels E11 to E44 emit a light.

Hereinafter, a process of driving the light emitting device will be described in detail.

The first scan line S1 is coupled to the ground, and the other scan lines S2 to S4 are coupled to a non-luminescent source having the same voltage as the driving voltage of the light emitting device.

Subsequently, a first data current corresponding to first display data is provided to the data lines D1 to D4. In this case, the first data current provided to the data lines D1 to D4 passes to the ground through corresponding pixels E11 to E41 and the first scan line S1. As a result, the pixels E11 to E41 corresponding to the first scan line S1 emit a light.

Then, the data lines D1 to D4 are discharged up to voltages corresponding to cathode voltages of the pixels E11 to E41 for a discharge period of time.

Subsequently, the data lines D1 to D4 are precharged to a level corresponding to second display data inputted to the controller 302 after the first display data are inputted to the controller 302.

Then, the second scan line S2 is coupled to the ground, and the other scan lines S1, S3 and S4 are coupled to the non-luminescent source.

Subsequently, a second data current corresponding to the second display data is provided to the data lines D1 to D4. As a result, the pixels E12 to E42 corresponding to the second scan line S2 emit a light.

Then, the data lines D1 to D4 are discharged for a discharge period of time.

The above process is repeatedly performed from the first scan line S1 to the fourth scan line S4.

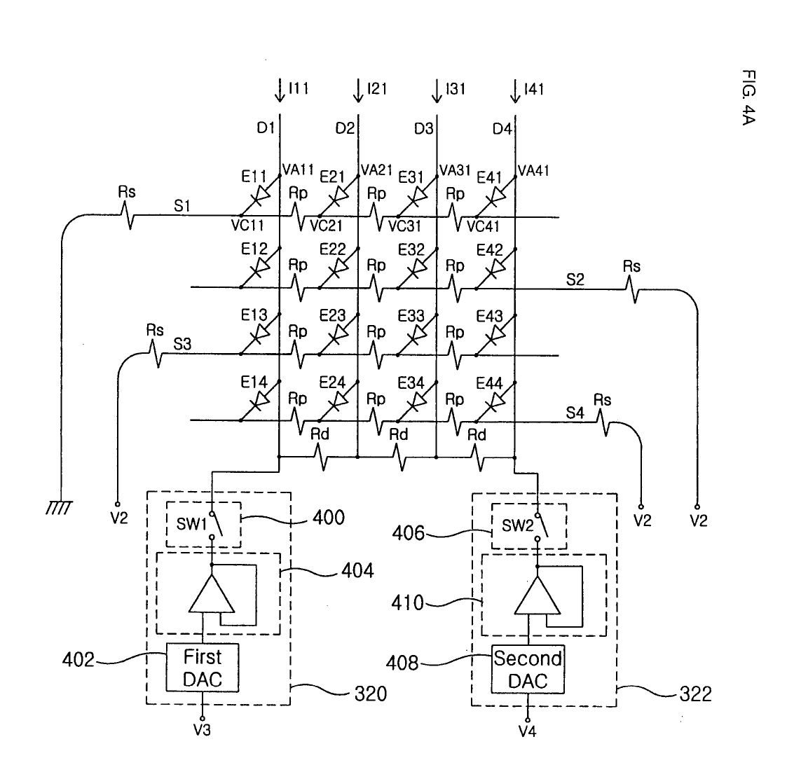

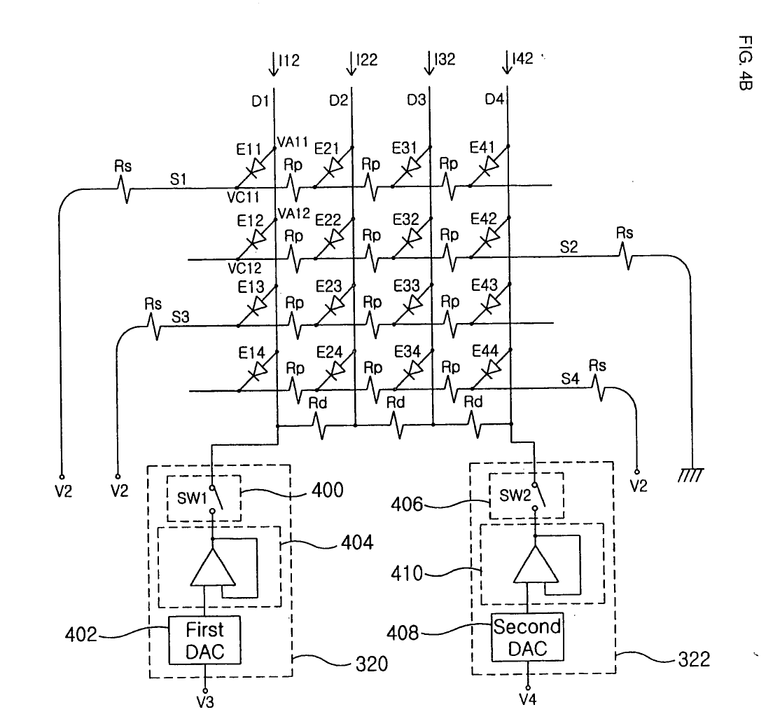

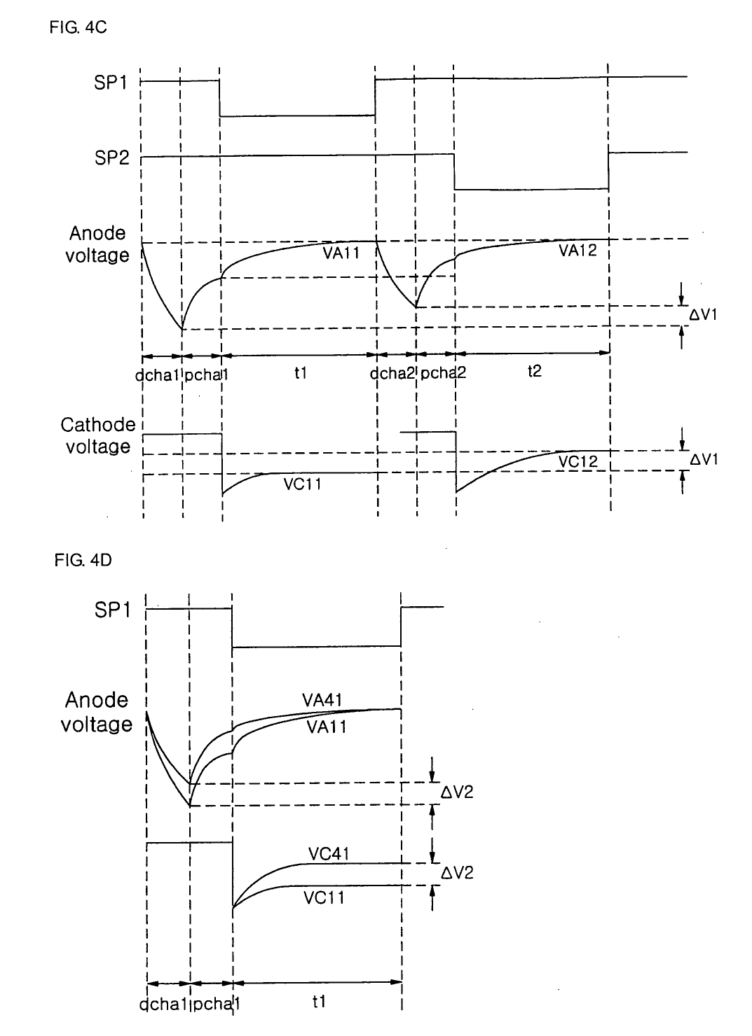

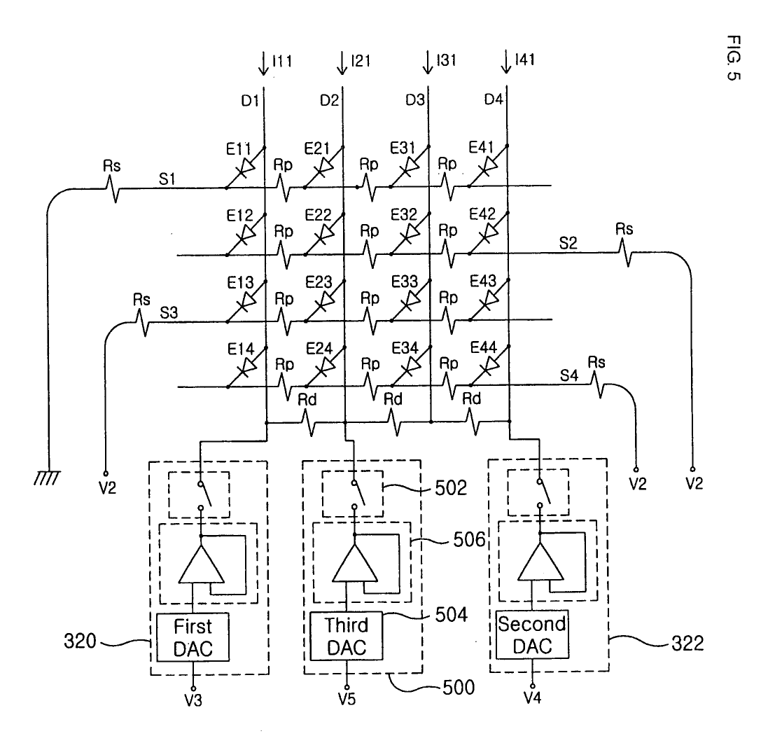

FIG. 4A and FIG. 4B are views schematically illustrating circuitries of the light emitting device of FIG. 3. FIG. 4C and FIG. 4D are timing diagrams illustrating a process of driving the light emitting device.

In FIG. 4A, the first sub discharging circuit 320 includes a first switch (SW1) 400, a first digital-analog converter (hereinafter, referred to as “first DAC”) 402, and a first buffer 404.

The second sub discharging circuit 322 includes a second switch (SW2) 406, a second DAC 408, and a second buffer 410.

Hereinafter, cathode voltages VC11 to VC44 will be explained, and then the process of driving the light emitting device will be described in detail. Here, cathode voltages VC11 to VC 41 corresponding to a first scan line S1 will be described as an example of the cathode voltages VC11 to VC44 for convenience of the description.

First, the cathode voltages VC11 to VC44 will be explained.

As shown in FIG. 4A, a resistor between a pixel E11 and the ground is scan resistor Rs, and a resistor between a pixel E21 and the ground is Rs+Rp. In addition, a resistor between a pixel E31 and the ground is Rs+2 Rp, and a resistor between a pixel E41 and the ground is Rs+3 Rp. Here, the cathode voltages VC11 to VC41 of the pixels E11 to E41 are proportioned to resistors between corresponding pixel and the ground, and thus the values are high in the order of the cathode voltages VC41, VC31, VC21 and VC11.

In FIG. 4B, a resistor between a pixel E12 and the ground is Rs+3 Rp, and so the cathode voltage VC12 is higher than the cathode voltage VC11.

Second, the process of driving the light emitting device will be described in detail.

The discharging circuit 308 discharges the data lines D1 to D4.

Hereinafter, a process of discharging the data lines D1 to D4 will be described in detail.

At the time of discharge, the first switch SW1 and the second switch SW2 are turned on, and the scan lines S1 to S4 are coupled to the non-luminescent source having a voltage V2.

Subsequently, the first DAC 402 outputs a first level voltage in accordance with a first outside voltage V3 inputted from the outside. Here, the outputted first level voltage is inputted to the first buffer 404. Additionally, the second DAC 408 outputs a second level voltage in accordance with a second outside voltage V4 inputted from the outside. Here, the outputted second level voltage is inputted to the second buffer 410.

Then, the first buffer 404 provides a certain current to the first outmost data line D1 in accordance with the inputted first level voltage, and so the first outmost data line D1 has a first voltage. In addition, the second buffer 410 provides a certain current to the second outmost data line D4 in accordance with the inputted second level voltage, and so the second outmost data line D4 has a second voltage different from the first voltage. Accordingly, the data lines D1 to D4 have sequentially different magnitudes of voltages, and thus are discharged up to different disaharge levels from each other at the time of discharge.

Only, in the above case, the cathode voltage VC41 is higher than the cathode voltage VC11, and thus the second voltage is higher than the first voltage.

Hereinafter, the pixel E41 is assumed to be designed to have the same brightness as the pixel E11.

In this case, the cathode voltage VC41 is higher than the cathode voltage VC11, and thus the fourth data line D4 is discharged up to a discharge voltage higher than the first data line D1 during a first discharge period of time (dcha1) as shown in FIG. 4D.

Subsequently, the data lines D1 to D4 are precharged for a first precharge period of time (pcha1). In this case, because the fourth data line D4 is discharged up to the discharge voltage higher than the first data line D1, the fourth data line D4 is precharged to a voltage higher than the first data line D1.

Then, the first scan line S1 is coupled to the ground, and the other scan lines S2 to S4 are coupled to the non-luminescent source.

Subsequently, data currents I11 to I41 corresponding to first display data are provided to the data lines D1 to D4, and then the data currents I11 to I41 provided to the data lines D1 to D4 passes to the ground through corresponding pixels E11 to E41 and the first scan line S1. As a result, the pixels E11 to E41 corresponding to the first scan line S1 emit a light for a first light emitting time t1. Only, each pixel emits a light whose brightness corresponds to the difference of its anode voltage and cathode voltage.

In this case, the fourth data line D4 is more precharged than the first data line D1, and thus the anode voltage VA41 is higher than the anode voltage VA11. Accordingly, the brightness of the pixel E41, i.e. VA41-VC41, is substantially identical to the brightness of the pixel E11, i.e. VA11-VC11.

A process of driving the pixel E21 and the pixel E31 is substantially identical to the process of the pixel E11 and the pixel E41. Accordingly, since the pixels E11 to E41 are designed to emit a light having the same brightness, the pixels E11 to E41 have substantially the same brightness.

Hereinafter, the process of driving the light emitting device will be described.

The scan lines S1 to S4 are coupled to the non-luminescent source, and the first and second switches SW1 and SW2 are turned on.

Subsequently, the first sub discharging circuit 320 provides a third voltage to the first outmost data line D1, and the second sub discharging circuit 322 provides a fourth voltage to the second outmost data line D4. Here, because a cathode voltage VC12 is higher than a cathode voltage VC42, the third voltage is higher than the fourth voltage. Accordingly, the data lines D1 to D4 are discharged up to discharge voltages having sequential magnitude.

Hereinafter, the discharge voltages corresponding to the pixels E11 and E12 will be compared.

Because the cathode voltage VC12 of the pixel E12 is higher than the cathode voltage VC11 of the pixel E11, the data line D1 is discharged up to a higher discharge voltage for a second discharge period of time (dcha2) than a first discharge period of time (dcha1).

Subsequently, a precharge current corresponding to second display data is provided to the data lines D1 to D4. Here, the second display data are inputted to the controller 302 after the first display data are inputted to the controller 302.

Then, the second scan line S2 is coupled to the ground, and the other scan lines S1, S3 and S4 are coupled to the non-luminescent source.

Subsequently, data currents 112, 122, 132 and 142 corresponding to the second display data are provided to the data lines D1 to D4. In this case, because the first data line D1 is discharged up to the higher discharge voltage for the second discharge period of time (dcha2) than the first discharge period of time (dcha1), an anode voltage VA12 is higher than an anode voltage VA11. Accordingly, when the pixels E11 and E12 are preset to have the same brightness, the brightness of the pixel E12, i.e., VA12-VC12, is substantially identical to the brightness of the pixel E11, i.e., VA11-VC11.

In brief, in the method of driving the light emitting device of the present invention, the anode voltage of a pixel is changed depending on the cathode voltage of the pixel, unlike in the light emitting device in the art. Accordingly, when the pixels are preset to have the same brightness, the pixels emit light having the same brightness irrespective of their cathode voltages. Hence, the cross-talk phenomenon is not occurred in the panel 300 included in the light emitting device of the present invention.

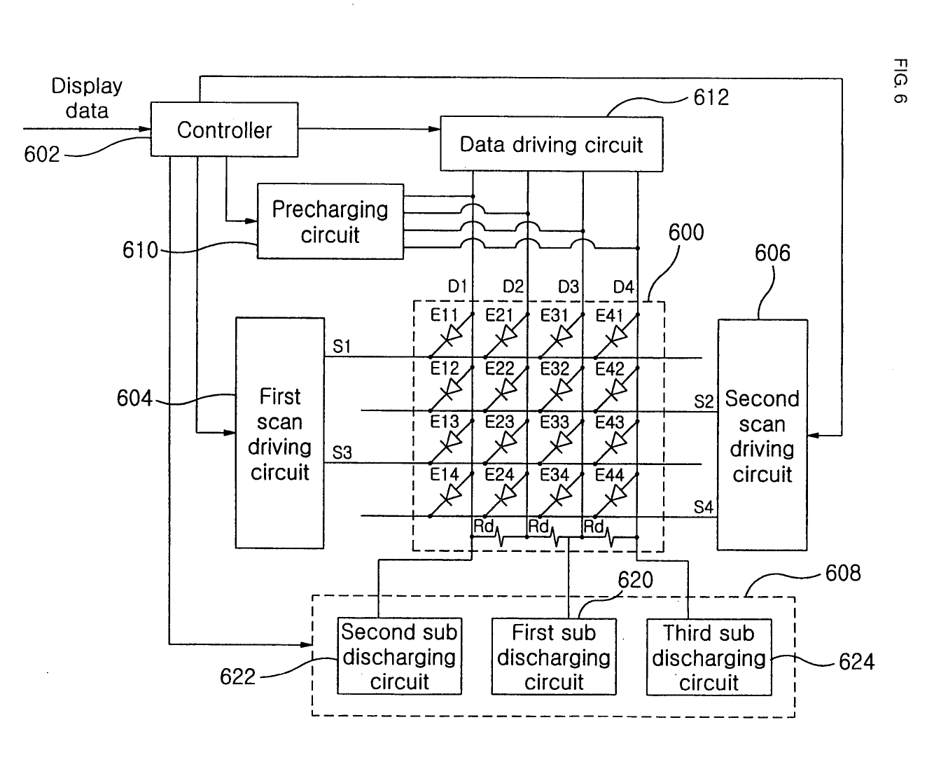

FIG. 5 is a view illustrating a circuitry of a light emitting device according to a second embodiment of the present invention.

In FIG. 5, the light emitting device of the second embodiment further includes one or more third sub discharging circuits 500 than the light emitting device of the first embodiment.

The third sub discharging circuit 500 provides a certain voltage to data line located between the outmost data lines D1 and D4. Here, the voltage has a magnitude of voltages provided to the outmost data lines D1 and D4.

In the first embodiment, it is assumed that the resistors (Rd) between the data lines D1 to D4 are same, the cathode voltages corresponding to a scan line are linearly changed. Accordingly, the cathode voltages could be compensated by using only the two sub discharging circuits 320 and 322.

However, the resistors between the data lines D1 to D4 are not the same, and so the cathode voltages may be nonlinearly changed. Accordingly, in the second embodiment, the light emitting device compensates the nonlinearly changing cathode voltages by using the third sub discharging circuit 500.

The third sub discharging circuit 500 of the present invention includes a third switch 502, a third DAC 504, and a third buffer 506. Since the elements of the third sub discharging circuit 500 are the same as in the first embodiment, any further detailed descriptions concerning the same elements will be omitted.

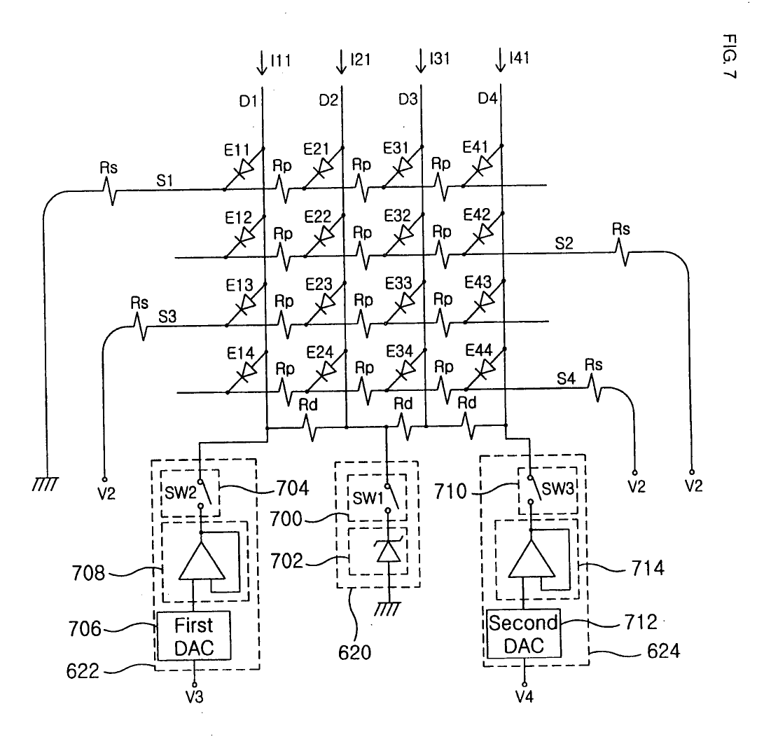

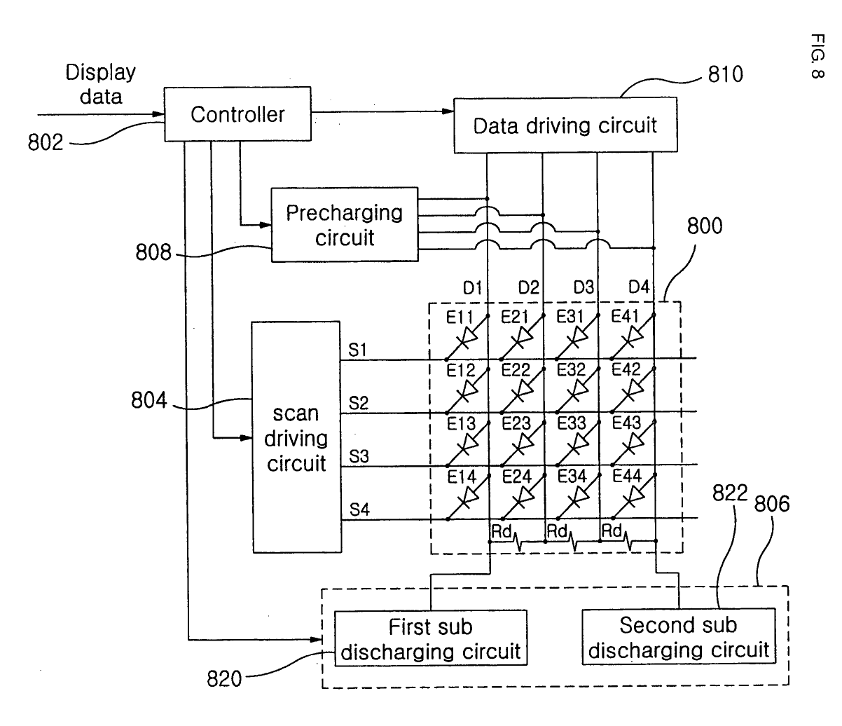

FIG. 6 is a block diagram illustrating a light emitting device according to a third embodiment of the present invention. FIG. 7 is a view illustrating a circuitry of the light emitting device of FIG. 6.

In FIG. 6, the light emitting device of the present invention includes a panel 600, a controller 602, a first scan driving circuit 604, a second scan driving circuit 606, a discharging circuit 608, a precharging circuit 610, and a data driving circuit 612.

Since the elements of the present invention except the discharging circuit 608 are the same as in the first embodiment, any further detailed descriptions concerning the same elements will be omitted.

The discharging circuit 608 includes a first sub discharging circuit 620, a second sub discharging circuit 622, and a third sub discharging circuit 624.

The first sub discharging circuit 620 discharges the data lines D1 to D4 up to a certain discharge voltage. For example, the first sub discharging circuit 620 discharges the data lines D1 to D4 up to a zener voltage of a zener diode 702 by using the zener diode 702 included therein, as shown in FIG. 7.

The second and third discharging circuits 622 and 624 compensate the cathode voltages of the pixels E11 to E44. For example, the second and third sub discharging circuits 622 and 624 include switches 704 and 710, DACs 706 and 712, and buffers 708 and 714.

In the first embodiment, the cathode voltages VC11 to VC44 are compensated by using the current outputted from the buffers 404 and 410, and so the power consumption of the light emitting device is high. However, in the third embodiment, the cathode voltages VC11 to VC44 are compensated by using the buffers 708 and 714 after the data lines D1 to D4 are discharged up to a certain discharge voltage by using the zener diode 702. Accordingly, the power consumption of the light emitting device in the third embodiment is lower than that of the light emitting device in the first embodiment.

FIG. 8 is a block diagram illustrating a light emitting device according to a fourth embodiment of the present invention.

In FIG. 8, the light emitting device of the present invention includes a panel 800, a controller 802, a scan driving circuit 804, a discharging circuit 806, a precharging circuit 808, and a data driving circuit 810. Since the elements of the present embodiment are the same as the first embodiment, any further detailed description concerning the same elements will be omitted.

In the fourth embodiment, the scan driving circuit 804 is disposed in one direction of the panel 800 unlike the other embodiments.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. A light emitting device comprising:
data lines disposed in a first direction;
scan lines disposed in a second direction different from the first direction;
a plurality of pixels formed in cross areas of the data lines and the scan lines; and
a discharging circuit configured to discharge at least two data lines, wherein the two data lines are discharged to different discharge voltages.

2. The light emitting device of claim 1, wherein at least one data line is discharged to a discharge voltage corresponding to a cathode voltage of a pixel corresponding to the data line.

3. The light emitting device of claim 1, wherein the discharging circuit provides a first voltage to one of the data lines, and provides a second voltage to other data line,
wherein the second voltage has different magnitude from the first voltage.

4. The light emitting device of claim 1, wherein the discharging circuit includes:
a first sub discharging circuit configured to provide a first voltage to a first outmost data line of outmost data lines; and
a second sub discharging circuit configured to provide a second voltage to a second outmost data line.

5. The light emitting device of claim 4, wherein the second voltage has different magnitude from the first voltage.

6. The light emitting device of claim 4, wherein the discharging circuit further includes a third sub discharging circuit configured to provide a third voltage to one of data lines located between the outmost data lines.

7. The light emitting device of claim 4, wherein at least one of the sub discharging circuits includes:
a buffer having an output terminal coupled to the corresponding data line; and
a digital analog converter (DAC) coupled to an input terminal of the buffer.

8. The light emitting device of claim 1, wherein the discharging circuit includes:
a first sub discharging circuit configured to discharge the data lines to a certain discharge voltage;
a second sub discharging circuit configured to provide a first voltage to a first outmost data line of outmost data lines; and
a third sub discharging circuit configured to provide a second voltage to a second outmost data line.

9. The light emitting device of claim 8, wherein the first sub discharging circuit includes a zener diode connected to the data lines, and
wherein at least one of the second and third sub discharging circuits includes:
a buffer having an output terminal coupled to the corresponding data line; and
a digital analog converter (DAC) coupled to an input terminal of the buffer.

10. The light emitting device of claim 8, wherein the second voltage has different magnitude from the first voltage.

11. The light emitting device of claim 1, further including:
a scan driving circuit configured to transmit scan signals to the scan lines; and
a data driving circuit configured to transmit data signals to the data lines.

12. The light emitting device of claim 1, further including:
a first scan driving circuit configured to transmit first scan signals to some of the scan lines;
a second scan driving circuit configured to transmit second scan signals to other scan lines; and
a data driving circuit configured to transmit data signals to the data lines.

13. The light emitting device of claim 1, wherein the light emitting device is organic electroluminescent device.

14. A light emitting device comprising:
data lines disposed in a first direction;
scan lines disposed in a second direction different from the first direction; and
a plurality of pixels formed in cross areas of the data lines and the scan lines,
wherein an anode voltage of at least one pixel has magnitude corresponding to its cathode voltage and display data.

15. The light emitting device of claim 14, further including:
a discharging circuit configured to provide a first voltage to a first outmost data line, and provide a second voltage to a second outmost data line, at the time of discharge,
wherein the second voltage has different magnitude from the first voltage.

16. The light emitting device of claim 15, wherein the data lines are discharged to a certain discharge voltage during a first discharge time, and the first and second voltages are provided to the outmost data lines during a second discharge time.

17. The light emitting device of claim 14, further including:
a discharging circuit configured to provide a first voltage to a first outmost data line, a second voltage to a second outmost data line, and a third voltage to other data line than the outmost data lines,
wherein the voltages have different magnitude from one another.

18. An electroluminescent device comprising:
data lines disposed in a first direction;
scan lines disposed in a second direction different from the first direction;
a plurality of pixels formed in cross areas of the data lines and the scan lines;
a first sub discharging circuit configured to provide a first voltage to a first outmost data line of the data lines; and
a second sub discharging circuit configured to provide a second voltage to a second outmost data line,
wherein the second voltage has different magnitude from the first voltage, and wherein each of anode voltages of pixels corresponding to the scan line has different magnitude depending on cathode voltage when a data current of same brightness is provided to the data lines.

19. The electroluminescent device of claim 18, wherein each of the data lines is discharged to a discharge voltage corresponding to the cathode voltage of corresponding pixel by the first and second voltages.

20. A method of driving a light emitting device having a plurality of pixels formed in cross areas of data lines and scan lines, comprising:
providing a first voltage to a first outmost data line of the data lines; and
providing a second voltage to a second outmost data line,
wherein each anode voltage of pixels corresponding to the scan line is different depending on cathode voltages of the pixels.

21. The method of claim 20, wherein the second voltage has different magnitude from the first voltage.

22. The method of claim 20, wherein the data lines are discharged to discharge voltages corresponding to the cathode voltages of the pixels by the first and second voltages.

23. The method of claim 20, further including:
discharging the data lines to a certain discharge voltage.

24. The method of claim 20, wherein the step of providing the first voltage includes:
outputting a first level voltage in accordance with a first external voltage; and
providing a first current to the first outmost data line in accordance with the outputted first level voltage, and
wherein the step of providing the second voltage includes:
outputting a second level voltage in accordance with a second external voltage; and
providing a second current to the second outmost data line in accordance with the outputted second level voltage.

25. The method of claim 20, further including:
providing a third voltage to one of the data lines located between the outmost data lines.

26. The method of claim 20, further including:
transmitting scan signals to the scan lines; and
transmitting data signals to the data lines.
